(19) United States
(12) Patent Application Publication
(10) Pub. No.: US 2012/0209942 A1
(43) Pub. Date: Aug. 16, 2012

(54) SYSTEM COMBINING A CDN REVERSE PROXY AND AN EDGE FORWARD PROXY WITH SECURE CONNECTIONS

(75) Inventors: Ronni Zehavi, Sunnyvale, CA (US); Udi Trugman, Alfe-Menashe (IL); David Drai, Kfar Yona (IL); Ido Safruti, San Francisco, CA (US)

(73) Assignee: Cotendo, Inc., Sunnyvale, CA (US)

(21) Appl. No.: 13/102,038

(22) Filed: May 5, 2011

Related U.S. Application Data
(63) Continuation-in-part of application No. 13/126,688, filed on May 25, 2011.
(60) Provisional application No. 61/193,092, filed on Oct. 28, 2008.

(51) Int. Cl. G06F 15/167

(52) U.S. Cl. 709/213

(57) ABSTRACT

A proxy system is provided to receive an HTTP request for content accessible over the Internet comprising: cache storage; and a computer system configured to implement, a CDN proxy module and an edge forward proxy module each having access to the cache storage to cache and to retrieve content; and a selector to select either the CDN proxy module or the edge forward proxy module depending upon contents of a header of the HTTP request received from the user device; an HTTP client to forward the request from the CDN proxy or from the edge forward proxy over the Internet to a server to serve the requested content.

### CROSS REFERENCE TO RELATED APPLICATION

This application is a continuation-in-part of commonly owned co-pending U.S. patent application Ser. No. 13/126,688, filed Apr. 28, 2011, and entitled, System Combining a CDN Reverse Proxy Server and a Transparent Proxy Server and Related Method, which is expressly incorporated herein by this reference.

### BACKGROUND

Content delivery networks (CDNs) comprise dedicated collections of servers located across the Internet. Three main entities participate in a CDN: content provider, CDN provider and end users. A content provider is one who delegates Uniform Resource Locator (URL) name space for web objects to be distributed. An origin server of the content provider holds these objects. CDN providers provide infrastructure (e.g., a network of proxy servers) to content providers to achieve timely and reliable delivery of content over the Internet. Proxy servers typically cache, or store, frequently accessed content, and then locally fulfill successive requests for the same content, eliminating repetitive transmission of identical content over network links. End users comprise the entities such as individuals or organizations such as businesses or government that use personal computers or communication devices such as smart phones to access content over a CDN, for example.

The basic architecture of the Internet is relatively simple: web clients running on users' machines use HTTP (Hyper Text Transport Protocol) to request objects from web servers. The server processes the request and sends a response back to the client. HTTP is built on a client-server model in which a client makes a request of the server.

In the context of CDNs, content delivery describes an action of delivering content over a network in response to end user requests. The term ‘content’ refers to any kind of data, in any form, regardless of its representation and regardless of what it represents. Content generally includes both encoded media and metadata. Encoded content may include, without limitation, static, dynamic or continuous media, including streamed audio, streamed video, web pages, computer programs, documents, files, and the like. Some content may be embedded in other content, e.g., using markup languages such as HTML (Hyper Text Markup Language) and XML (Extensible Markup Language). Metadata comprises a content description that may allow identification, discovery, management and interpretation of encoded content.

More particularly, a CDN often is used to deliver content such as Web pages, streaming media and applications to the user's computer. Such network is composed of geographically distributed content delivery nodes that are arranged for efficient delivery of content on behalf of third party content providers. A request from an end user for given content is directed from the computer of the end user to the Internet through a “point of presence”, such as an Internet Service Provider (ISP), and hence to a server of the CDN (rather than being sent to the server of the content provider itself). Such routing minimizes the response time for data requests and provides high quality bandwidth for streaming media. Also such networks provide more efficient and cost-effective distribution to the computers of end users. Unfortunately such connections still result in a great deal of traffic between the point of presence and the content server.

In a typical CDN service, a caching proxy will cache the content locally. However, if a caching proxy receives a request for content that has not been cached, it generally will go directly to an origin server to fetch the content. A proxy, sometimes referred to as a proxy server, acts as both a server and a client for the purpose of making requests on behalf of other clients. In this manner, the overhead required within a CDN to deliver cacheable content is minimized.

A CDN proxy ordinarily comprises a reverse proxy server that proxies on behalf of one or more backend HTTP servers such as an origin server or another proxy server, for example. A reverse proxy server retrieves and caches content on behalf of an end user from one or more other servers. A reverse proxy appears to an end user as an ordinary server with its own IP address and does not need to ‘fake’ a backend server's IP address when communicating with the end users. The content is returned to the user as though it originated from the reverse proxy itself. A CDN reverse proxy generally is configured to handle specific predefined/preconfigured domains where each domain has its own configuration set known as cache settings, and a different destination server known as origin server identified by an origin address.

A forward proxy acts as a gateway from a client to the Internet, sending client HTTP requests on behalf of the client. A forward proxy may protect an inside network by hiding the client's actual IP address and using its own instead. In particular, for example, a forward proxy may implement a NAT (network address translation) when forwarding a served client request to the world (i.e. the origin servers), where communication to the outer world is typically done on a separate interface, making the forward proxy also a NAT bridge. Another alternative forward proxy implementation involves the forward proxy forwarding the user device's requests to the origin server while keeping the original end user IP address as the source IP address.

A CDN region (e.g., one or more CDN reverse proxy servers) may be co-located with a forward proxy operating as an edge server on behalf of an Internet Service Provider (ISP) Point of Presence (PoP). As used herein, an ISP (Internet Service Provider) is an organization such as a company which primarily offers access to the Internet using any type of data communication to its customers, whether through dial-up telephone access, wireless access, wired access (such as cable, broadband or the like), satellite access or any other type of access. As used herein, the term ‘ISP’ may optionally refer to any service provider or connector which enables end user computers or other client computers, such as enterprise client forward proxy servers, to connect to the Internet, including any type of PoP. As used herein, a PoP (Internet point of presence) comprises an access point to the Internet or a datacenter located in a region or network. Thus, a PoP is not only an access point. It could also be a place including the mentioned servers located within some “presence” that is—in some specific location: region, datacenter, or network. A PoP typically includes a physical location that houses servers, routers, ATM switches and digital/analog call aggregators. ISPs typically have multiple POPs. An edge server is any server that resides on the ‘edge’ between two networks, typically a private network and the Internet. Such private network may include one or more of POTS, DSL, lease lines, cable, satellite or wireless networks, for example. In the case of a CDN implementation ian edge server could be either as described here, or on the edge of the “core” internet—closer to the “eye-ball” networks, that is—closer to the actual end-users. An edge forward proxy operates on behalf of an Internet access provider ISP PoP, mobile carrier, enterprise, or large organization.

Edge forward proxies often combines a proxy server with a gateway or router, commonly with NAT capabilities. Connections made by user device client browsers through the gateway are diverted to the edge forward proxy without client-side configuration (or often knowledge). Connections may also be diverted from a SOCKS server or other circuit-level proxies, for example. Persons skilled in the art know that SOCKS is an Internet protocol that facilitates the routing of network packets between client-server applications via a proxy server. Edge forward proxies can offer a wide range of features such as policy management and content adaptation for devices such as browsers/mobile devices and other features that help to maintain an effective operator backbone, saving internal bandwidth using compression techniques, and improving end users experience through technologies such as caching, run time transarating (adjusting video transcoder resolution based upon error rate and bandwidth availability), run time transcoding and more, for example.

Edge forward proxies also typically provide cache storage although such caching is not always efficient due to the enormous scale needed in order to cache the large volume of requests passing through an edge forward proxy located at an ISP, for example. One of the reasons for this inefficiency of scale is the fact that popularity of a requested content object often is not known. When an edge forward proxy receives a request, it may cache the first retrieved copy of the content in disk storage assuming that the next request will be served from the cache storage so as to reduce upstream traffic. However, in a ‘long tail’ environment (i.e. a very large library of objects, accessed not very frequently) such as in an ISP environment where millions of end users access the content of so many web sites, it is difficult to predict which stored content object will be requested again in a reasonable time period so as to avoid caching large volumes of information, perhaps hundreds of Terra Bytes (TB) of data before this content object is accessed again.

The CDN proxy server approach to caching is different from that of the typical edge forward proxy. A direct dialog between a CDN provider and the content providers can lead to a more effective caching. For instance, when a content provider has long tail content the content provider can indicate, or instruct the CDN provider so that those kinds of content objects may have lower cacheing priority meaning that they are less likely to be cached so as to displace higher priority cached content. Conversely, when there are pre-known popular objects the CDN provider can increase their cache priority, store them in disk for a long period, prefetch them, and even store them in CDN proxy server RAM for better performance. Moreover, a CDN proxy provides a service only for the content providers, which are typically the customers of the CDN. By that, not only does it know better how to prioritize the specific content of each of the content providers, it also has only the specified content providers to serve, and not the entire internet content, by that ensuring better and more predictable and efficient service.

FIG. 1 is an illustrative functional block diagram representing a typical flow of information between an end user device 102, a forward edge proxy 104 and a content provider destination server 106 disposed within an ISP PoP 108 at the ‘edge’ of the Internet. In the illustrative example, the user device 102 makes a DNS request to DNS server 110 in order to resolve destination server 106's IP address. The user device 102 then makes an HTTP request over a network to the edge forward proxy 104. For example, the end user device 102 generates a request for content provided by the destination server 106. In the illustrative example, the request includes an address, IPx, indicative of the destination server 106 that is the origin of the requested content. The edge forward proxy 104 intercepts the request from the device 102 (by bridging all HTTP requests for instance) and responds to the end-user device 102 as if it was the destination server, using the server's IP address, IPx.

More particularly, the edge forward proxy server 104 inspects the request and determines whether the requested content has been cached in cache storage (not shown) within the edge forward proxy, or next to it in the ISP PoP 108. If the transparent proxy server 104 determines that the requested content has been cached and that the cached content is fresh, then the edge forward proxy server 104 sends the cached content to the requesting user device 102 without requesting the content from the destination server 106.

If on the other hand, the edge forward proxy 104 determines that the requested content is not cached within the ISP PoP 108 (i.e. a cache miss), or is cached but not fresh (i.e. the TTL set for this content has expired), then the edge forward proxy 104 makes a request to the destination server 106 at address IPx to fetch the requested content. In the illustrative example, the edge forward proxy 104 makes the request to the destination server 106 having address IPx, and the destination server 106 returns the content to the edge forward proxy server at address IPy. The edge forward proxy server 104 may cache the returned content and then sends the returned content to the requesting user device 102.

FIG. 2 is an illustrative functional block diagram representing a typical flow of information within a CDN network overlayed on the Internet. For example, in operation a client user device 202 sends a DNS request to resolve the IP address for the name of the service it wants to access (for instance www.domain.com). The request is eventually sent to a DNS (Domain Name System) server 204 (directly or through a caching DNS server provided by the ISP, not illustrated in this figure). Server 204 is a CDN's DNS server, authoritative for requests to access specific domains served by the CDN.

With a CDN, typically the user wants to access a domain. To get the IP a DNS query is issued. It will go to the authoritative DNS server of the content provider, which will typically return a CNAME record. The CNAME's record will then be resolved by the CDN's DNS server and will eventually (maybe through some additional CNAMEs) provide an IP address of a CDN proxy server which was determined by the DNS server as the best to serve the content for this user.

Persons skilled in the art know that the Internet maintains two principal namespaces, the domain name hierarchy and the Internet Protocol (IP) address system. The Domain Name System maintains the domain namespace and provides translation services between these two namespaces. The DNS 204 responds by sending to the requesting user device 202 an address, IPx, which in this example is the IP address for the CDN proxy server 206. The CDN proxy server 206, which may be disposed within the ISP PoP 108, typically includes a configuration module (not shown) containing a lookup table with configuration settings per domain served by the CDN proxy 206. The configuration table includes settings related to the specific domain sought by user device 202. One of the settings, for instance, identifies the address (or addresses), IPv in this example, of the content provider server 208 that provides the requested content, also referred to as the content provider origin server.

Persons skilled in the art will also know that the resolution process actually involves some additional steps in the common case—may involve a caching DNS server, finding the authoritative server through the DNS root servers, and potentially resolving several requests due to CNAMEs. For simplicity, we refer to this entire process as one “block” or request.

The CDN server 206 does not need to pretend to be the server 208, or serve content using the address of the content provider server 208 since the client user device 202 initiates a connection to the CDN's proxy's 206 address, IPx in this example, to begin with. A business relationship or understanding between the owner or operator of the content provider server 208 and the CDN vendor who owns or operates the CDN proxy 206 defines a pre-defined agreed-upon setting to the DNS entry for the authoritative DNS server (not shown) which is the authoritative DNS server for the content provider's domain (usually by using a CNAME record) of the domain to point into one or more CDN proxy servers 206.

Furthermore, a CDN manager 210 specifies cache rules that comprise settings employed by the CDN proxy server 206 to achieve more powerful caching and performance efficiency, as well as actions to control delivery and manage the cached content. For example, pursuant to agreement with the content provider, the CDN manager 210 may give a capability to the content provider (or someone on its behalf) to purge/flush content cached on the CDN proxy (in case the content on the origin was changed for instance, or a problem with the cached content was found) the CDN manager 210 may also be configured with rules to make content and network optimizations that edge forward proxies are not allowed to perform without the content provider's permission, for instance modifying the content to not serve images for certain devices (or serve a different version of the image), inject java scripts, cache an object on the proxy for a longer time than instructed to cache on a browser cache, dictate whether content is to be retrieved from local cache, hierarchical cache or through dynamic site acceleration (DSA) and more. When permitted by the content provider, the CDN server can also handle SSL communication for the content provider. This could be done if the content provider gives the SSL certificate to the CDN and authorizes the CDN to handle its secure/encrypted traffic.

The CDN server 206 does not imitate the address of the content provider server 208 since the client user device 202 initiates a connection to the CDN's proxy's 206 address, IPx in this example, to begin with. A business relationship or understanding between the owner or operator of the content provider server 208 and the CDN vendor who owns or operates the CDN proxy 206 defines a pre-defined agreed-upon change the of the DNS entry for the in DNS server 208 (usually using CNAME) of the domain to point into one or more CDN proxy servers 206. Sometimes, more than one domain name resolves to the same IP address, and in such situations, a CNAME (canonical name) is useful to resolve different domain names to a common IP address.

Furthermore, a CDN manager 210 specifies cache rules that comprise settings employed by the CDN proxy server 206 to achieve more powerful caching and performance efficiency, as well as actions to control delivery and manage the cached content. For example, pursuant to agreement with the content provider, the CDN manager 210 may give a capability to the content provider (or someone on its behalf) to purge/flush content cached on the CDN proxy (in case the content on the origin was changed for instance, or a problem with the cached content was found) the CDN manager 210 may also be configured with rules to make content and network optimizations that edge forward proxies are not allowed to perform without the content provider's permission, for instance modifying the content to not serve images for certain devices (or serve a different version of the image), inject java scripts, cache an object on the proxy for a longer time than instructed to cache on a browser cache, dictate whether content is to be retrieved from local cache, hierarchical cache or through dynamic site acceleration (DSA) and more. When permitted by the content provider, the CDN server can also handle SSL communication for the content provider. This could be done if the content provider gives the SSL certificate to the CDN and authorizes the CDN to handle its secure/encrypted traffic.

When the CDN proxy 206 receives the request from the user device 202, for example, the CDN proxy 206 inspects the request and determines whether the requested content has been cached in the proxy server (or another proxy server close to it, like in the hierarchical caching case). The CDN proxy 206 also determines how the request should be handled (which content provider, content settings, and so on)—based on the host string of the request, and other parameters, for example. If the CDN proxy 206 determines that the requested content has been cached and that the cached content is fresh, then the CDN proxy server 206 sends the cached content to the requesting user device 202 without requesting the content from the origin server 208. If on the other hand, the CDN proxy 206 determines that the requested content is not cached or is cached but not fresh, then the CDN proxy server 206 makes a request to the origin server 208 at address IPv to fetch the requested content. The CDN proxy server 206 determines the address, IPv, of the origin server based upon the configuration tables or files described above. The CDN proxy 208 may cache the returned content and sends to the user device 202 the content returned by the content provider origin server 208 in response to the request.

It will be appreciate that in general, CDN proxies can cache content more efficiently than can edge forward proxies. One reason is that CDNs are selective about the domains they manage (only domains of the content providers they are engaged with). Moreover, CDNs provide additional rules and capabilities such as cache prioritization rules to the content providers to better manage content caching and content delivery. These rules are specified in the CDN configuration and may include one or more of specific instructions on how to serve the content, how to store the content (or not to store at all), providing a different TTL to the CDN proxy than to the end-user, setting priority on content, providing capabilities to purge/flush content proactively by the CP, and more. More generally, the finer control that can be exercised by CDNs over the caching and delivery of content arises because content providers are aware of the CDN, and the CDN is aware of the served domains.

FIG. 3 is an illustrative drawing of a typical co-located edge forward proxy 104 and a CDN proxy 206. Components that are identical to those of FIGS. 1-2 are identified with identical reference numbers. Operation of the edge forward proxy 104 and the CDN proxy 206 are described with reference to FIGS. 1-2. Both the edge forward proxy 104 and the CDN proxy 206 operate independently and cache content separately. The edge forward proxy 104 caches content in cache storage 307, and CDN proxy 206 caches content in cache storage 309 Thus, the same content may be cached in different cache storage locations by both the edge forward proxy 104 and by the CDN proxy 206, resulting in an overall less efficient resource management—utilizing twice the cache size needed and adding an extra hop for such requests.

### SUMMARY

In some embodiments, a proxy system includes cache storage. A computer system is configured to implement both a CDN proxy module and an edge forward proxy, both configured to access the cache storage to cache and to retrieve content. A selection module select evaluates contents of an HTTP request and selects either CDN proxy module or the edge forward proxy module based upon the evaluation. An HTTP client forwards the request from either the CDN proxy or from the edge forward proxy over the Internet to a server to serve the requested content.

In some embodiments, a method is provided to use cache storage when responding to an HTTP request for content accessible over the Internet. A determination is made as to whether the request is for content served by a CDN proxy. If the request is determined to be for content served by a CDN, then the cache storage is accessed to retrieve the content if the requested content is stored in cache storage and configuration rules used by the CDN are accessed and used to forward the request over the Internet to a server to serve the requested content if the requested content is not stored in the cache storage. If the request is determined not to be for content served by a CDN, then the cache storage is accessed to retrieve the content if the requested content is stored in the cache storage and the request is forwarded over the Internet to a server to serve the requested content without using configuration rules if the content is not stored in the cache storage.

In some embodiments, a method is provided to respond to an HTTP request for content accessible over the Internet. Determinations are made as to whether an HTTP request is encrypted using SSL and whether the HTTP request is for content served by a CDN. CDN configuration rules are used to obtain content served by a CDN both for HTTP requests that are SSL encrypted and for HTTP requests that are not SSL encrypted. CDN configuration rules are not used to obtain content not served by a CDN either for HTTP requests that are SSL encrypted and for HTTP requests that are not SSL encrypted. A common cache storage is used to store content returned both for CDN HTTP requests and non-CDN HTTP requests and a duplicate copy of content returned for a CDN HTTP request is not stored in the cache storage.

### BRIEF DESCRIPTION OF THE DRAWINGS

The invention is herein described, by way of example only, with reference to the accompanying drawings. With specific reference now to the drawings in detail, it is stressed that the particulars shown are by way of example and for purposes of illustrative discussion of the preferred embodiments of the present invention only, and are presented in order to provide what is believed to be the most useful and readily understood description of the principles and conceptual aspects of the invention. In this regard, no attempt is made to show structural details of the invention in more detail than is necessary for a fundamental understanding of the invention, the description taken with the drawings making apparent to those skilled in the art how the several forms of the invention may be embodied in practice.

In the drawings:

FIG. 1 is an illustrative functional block diagram representing a typical flow of information between a client device, a forward edge proxy and a content provider destination server disposed within an ISP PoP at the ‘edge’ of the Internet.

FIG. 2 is an illustrative functional block diagram representing a typical flow of information within a CDN network overlayed on the Internet.

FIG. 3 is an illustrative drawing of a typical co-located edge forward proxy and a CDN proxy.

FIG. 4 is an illustrative generalized block diagram of a combined proxy system in accordance with some embodiments.

FIG. 5A is an illustrative functional block diagram showing additional details of the combined proxy of FIG. 4 in accordance with some embodiments.

FIG. 5B is an illustrative functional block diagram showing additional details of the CDN proxy module of FIG. 5A in accordance with some embodiments.

FIG. 5C is an illustrative functional block diagram showing additional details of the edge forward proxy module of FIG. 5A in accordance with some embodiments.

FIG. 6 is an illustrative flow diagram representing additional details of operation of the domain selector module of FIG. 5A in accordance with some embodiments.

FIG. 7 is an illustrative flow diagram representing additional details of operation of the CDN proxy module of FIG. 5A in accordance with some embodiments.

FIG. 8 is an illustrative flow diagram representing additional details of operation of the edge forward proxy module of FIG. 5A in accordance with some embodiments.

FIG. 9 is an illustrative block diagram representing control relationships among CDN managers and CDN proxies and between CDN managers and CDNs of combined proxies in accordance with some embodiments.

FIG. 10A is an illustrative flow diagram in which control flow branches based upon whether a received HTTP request is encrypted in an alternative embodiment of the combined proxy server.

FIG. 10B is an illustrative flow diagram in which an HTTP request determined to be encrypted with SSL is processed in accordance with some embodiments.

FIG. 10C is an illustrative flow diagram in which an HTTP request determined to not be encrypted with SSL is processed in accordance with some embodiments.

FIG. 11 is a block diagram of machine in the example form of a computer system within which instructions, for causing the machine to perform any one or more of the methodologies discussed herein, may be executed.

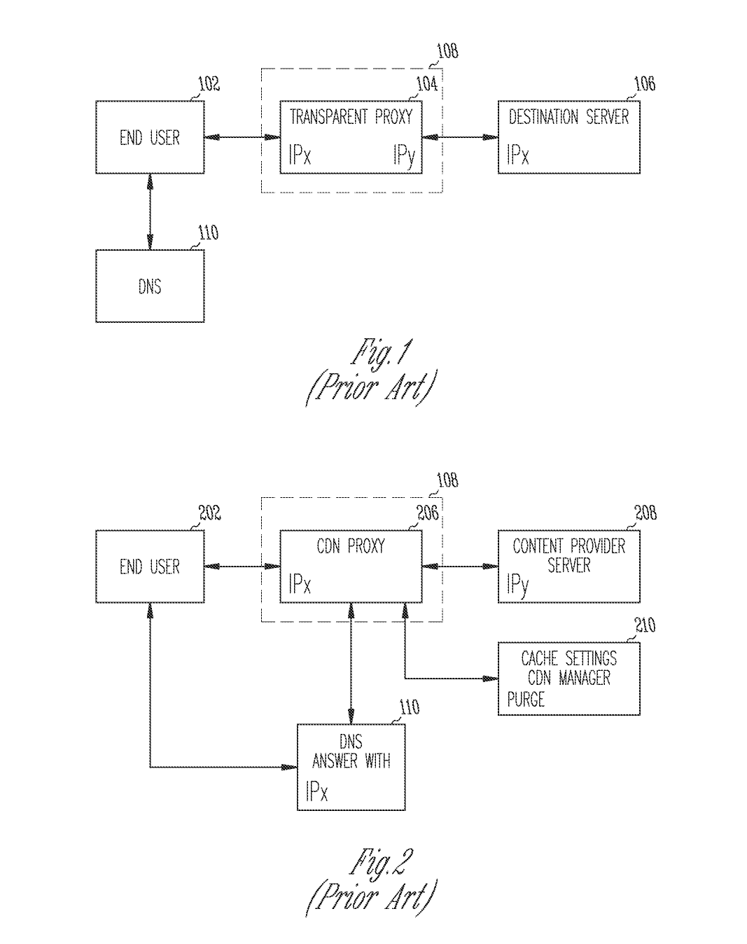

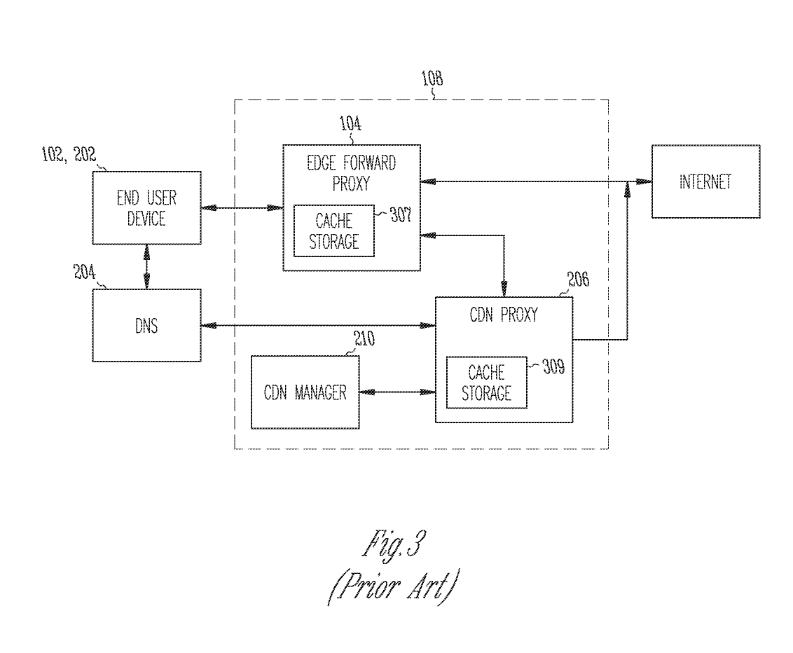

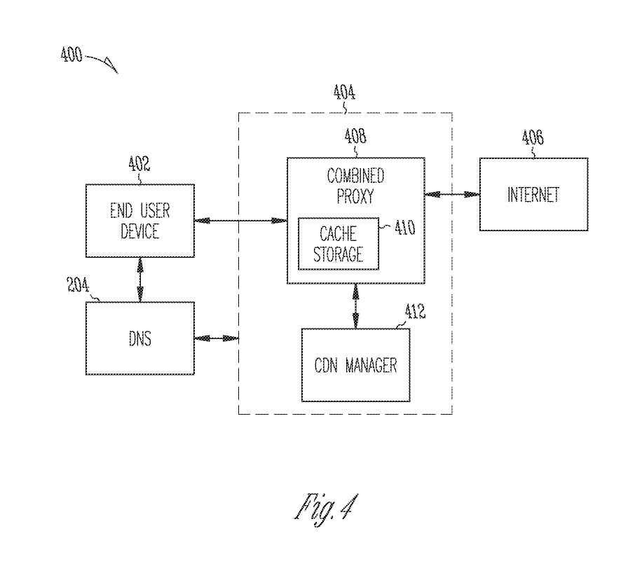

### DESCRIPTION OF THE EMBODIMENTS

The following description is presented to enable any person skilled in the art to make and use a computer implemented system and method and article of manufacture pertaining to a combined CDN reverse proxy server and a edge forward proxy, in accordance with the invention, and is provided in the context of particular embodiments, applications and their requirements. Various modifications to the disclosed embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention might be practiced without the use of these specific details. In other instances, well-known structures and processes are shown in block diagram form in order not to obscure the description of the invention with unnecessary detail. Components shown in one drawing that are identical to or substantially the same as components shown in a different drawing are indicated by identical reference numbers in both drawings. Thus, the present invention is not intended to be limited to the embodiments shown, but is to be accorded the widest scope consistent with the principles and features disclosed herein.

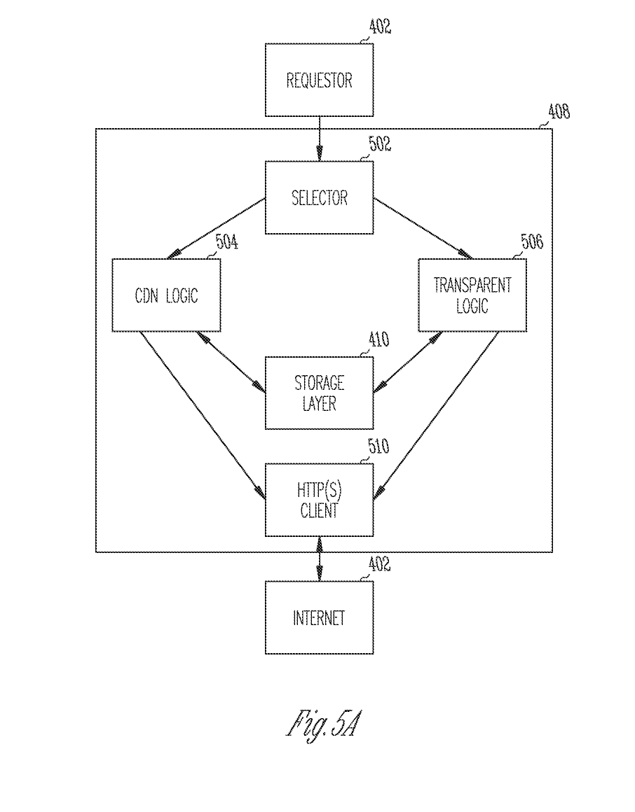

FIG. 4 is an illustrative generalized block diagram of a combined proxy system 400 in accordance with some embodiments. The proxy 400 comprises a computer system that includes one or more processors, storage and network connections and that is configured with computer program code to implement modules described below. User devices 402, such as browsers or mobile clients, send communications traffic through an ISP/private network 404 to the public Internet 406. Within ISP/private networks 404, a combined proxy 408 containing cache storage 410 are installed that acts as both an edge forward proxy and as a CDN proxy. The combined proxy 408 and the cache 410 may be disposed at an ISP PoP. CDN configurations that set forth rules used by the one or more CDN servers within the combined server 408 such as identification of the domains supported by the CDNs, origin server addresses and cache settings are distributed by a CDN manager 412.

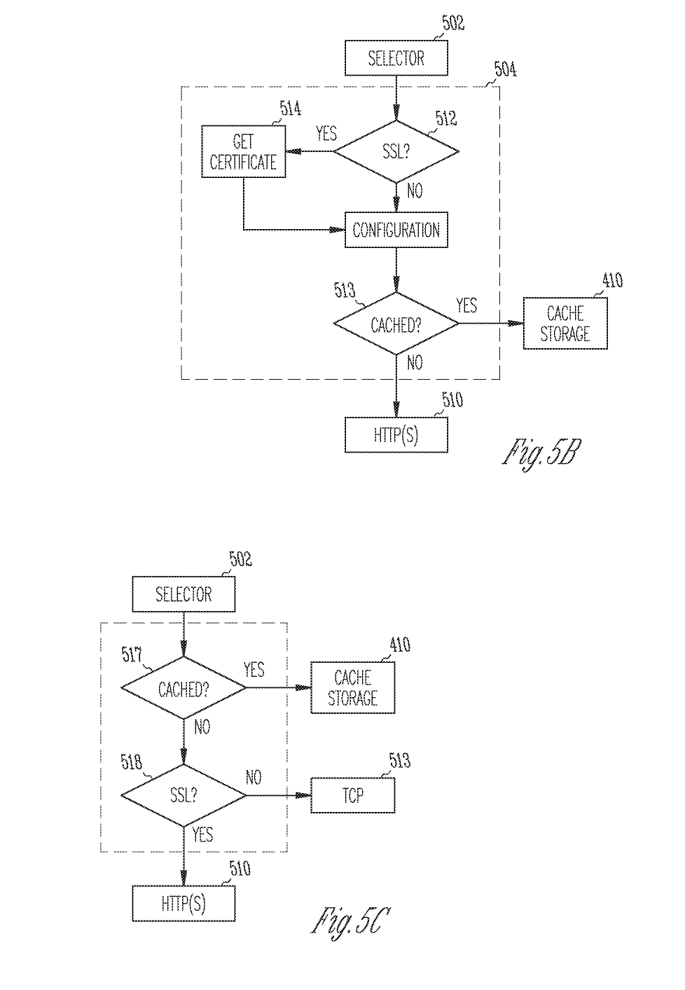

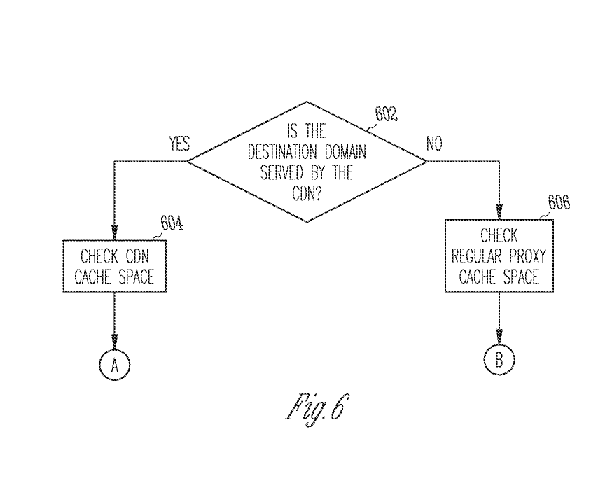

FIG. 5A is an illustrative functional block diagram showing additional details of the combined proxy 408 of FIG. 4 in accordance with some embodiments. A person skilled in the art will appreciate that a hardware computer system is configured with computer program code to implement the modules shown in FIG. 5A. Selector module 502 receives a request from a user device 402, whether directly or through a forward proxy (not shown), and determines whether the request should be processed by CDN proxy module 504 or by edge forward proxy module 506. The respective proxy server modules 504, 506, in turn, determine whether the requested content is cached within the cached content storage 410, and if not, direct an HTTP(S) client module 510 to send a request for the content over the public Internet 312.

The selector 502 makes the above selection based upon header information in a request received from a user device 302. The following is example header information from an HTTP request, for instance—an illustration of a portion of the request header:

GET/index.html HTTP/1.1

Host: www.site.com

The sector 502 selects based upon the host string in the HTTP header (e.g., www.site.com) in the above example or based upon the IP destination address (not shown). Although only one CDN proxy 504 is shown in FIG. 5A, it will be appreciated that multiple CDN proxy modules (not shown) may be combined with the edge forward proxy module 506 and that the selector 502 may direct the request to individual ones of those CDN proxies based upon HTTP header contents.

FIG. 5B is an illustrative functional block diagram showing additional details of the CDN proxy module 504 of FIG. 4A in accordance with some embodiments. SSL determination module 512 determines whether the request is encrypted with SSL. If the request is SSL encrypted then module 514 determines the appropriate SSL certificate to use for this connection (if any) and obtains that certificate to further decrypt the request and forwards the further decrypted request to configuration module 516. The configuration module 516 determines processing of the request, which may involve use of a configuration file (not shown) to determine whether to use local cache, hierarchical cache or dynamic site acceleration, for example. If the configuration module 516 determined that the request is to be served from cache, decision module 513 determines whether the requested content is already cached locally. If the requested content is cached locally in cache storage 410, then the content is retrieved from cache storage 410 and is sent to the requester of the content. If the requested content is not cached locally, the configuration module 516 forwards the request through the HTTP(S) client 510. Typically the client uses ordinary HTTP to process ordinary (i.e., non-SSL) HTTP requests and uses HTTPS to process SSL protected HTTPS requests, however the content provider (customer) can determine in the configuration the required method to access the origin—for instance accessing over HTTP even when the original request was over HTTPS. Content returned from an origin server (not shown) is stored in cacheable content storage 410 in accordance with rules specified by the CDN provider. If the SSL determination module 512 determines that the request is not SSL encrypted then module 514 sends the request to the configuration module 516 for processing as described above. Commonly owned co-pending U.S. patent application Ser. No. 12/758,017, filed Apr. 11, 2010, entitled Proxy Server Configured For Hierarchical Caching and Dynamic Site Acceleration, discloses SSL processing and use of a configuration file by a CDN proxy and is expressly incorporated herein by this reference.

FIG. 5C is an illustrative functional block diagram showing additional details of the edge forward proxy module 506 of FIG. 5A in accordance with some embodiments. Decision module 518 determines whether the request is encrypted using SSL (or a similar secured HTTP connection). If the request/connection is encrypted—the edge forward proxy can not decrypt it, as it has no relations to the content provider, and thus doesn't have the certificate of the content provider. In that case it can either block the connection (not common) or bypass the HTTP proxy module and forwarding the connection to the server determined by the request, by either forward the packets (NAT-ing them, or as is), or opening a TCP connection to the origin and forwarding the TCP stream as is. If the connection is not encrypted—decision module 517 determines whether the requested content is cached locally. If the requested content is cached locally in cache storage 410, then the content is retrieved from cache storage 410 and is sent to the requester of the content. If determination module 518 determines that the request is not cached, then it forwards the request through the HTTP client 510. It will be appreciated that DNS may be employed at this stage to determine origin server IP address, in some implementations. Content returned from an origin server (not shown) is stored in cacheable content storage 410.

It will be appreciated that one or the other of the CDN proxy 504 or the edge forward proxy module 506 stores content in cacheable content storage 410. Thus, duplicate cacheable storage can be reduced.

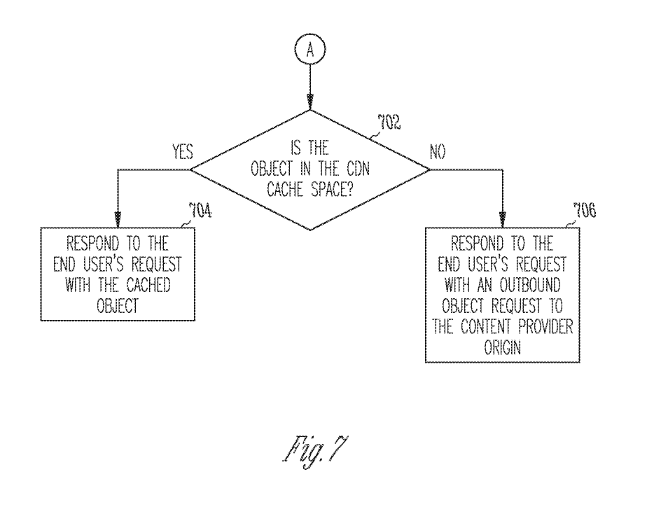

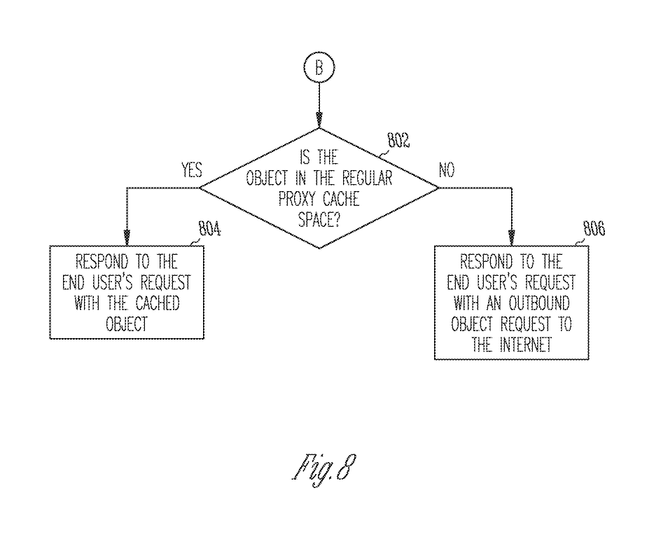

FIG. 6 is an illustrative flow diagram representing additional details of operation of the selector module 502 of FIG. 5A in accordance with some embodiments. Decision module 602 determines as described above with reference to item 502 whether a destination domain indicated within the received request is served by a CDN. If yes, then module 604 directs control flow to CDN module 504, which implements the process of FIG. 7, discussed below. If no, then module 606 directs control flow to edge forward proxy module 506, which implements the process of FIG. 8 discussed below.

FIG. 7 is an illustrative flow diagram representing additional details of operation of the CDN proxy module 504 of FIG. 5A in accordance with some embodiments. Assuming that the configuration module 516 determines that content is cacheable (as contrasted with content delivered through Dynamic Site Acceleration), then decision module 702 determines whether a first storage region within the cache storage 410 allocated to the CDN proxy 504 contains a cached copy of the requested content that is fresh. If yes, then module 704 responds to the user device request by providing the cached content to the requester. If no, then module 706 directs control flow to HTTP(S) client module 510 which forwards the request over the Internet content in accordance with determinations by the configuration module 516 to an server that can provide the.

FIG. 8 is an illustrative flow diagram representing additional details of operation of the edge forward proxy module 506 of FIG. 5A in accordance with some embodiments. Decision module 802 determines whether a second storage region within the cache storage 410 allocated to the edge forward proxy 506 contains a cached copy of the requested content that is fresh. If yes, then module 804 responds to the user device request by providing the cached content to the user device If no, and the request is not SSL encrypted, then module 806 directs control flow to the HTTP(S) client module 510, which forwards the request to a destination server (not shown) accessible over the public Internet indicated by the request. Additional details of differences in the handling SSL and non-SSL HTTP requests are provided above.

It will be appreciated that modules of the flow in FIGS. 5-8 correspond to configuration of a machine such as a computer system to implement acts identified by the modules. The different modules described above could all be modules running on the same combined proxy server, utilizing shared implementations of relevant components, or could be implemented on collocated separate servers having the request routed between the different servers.

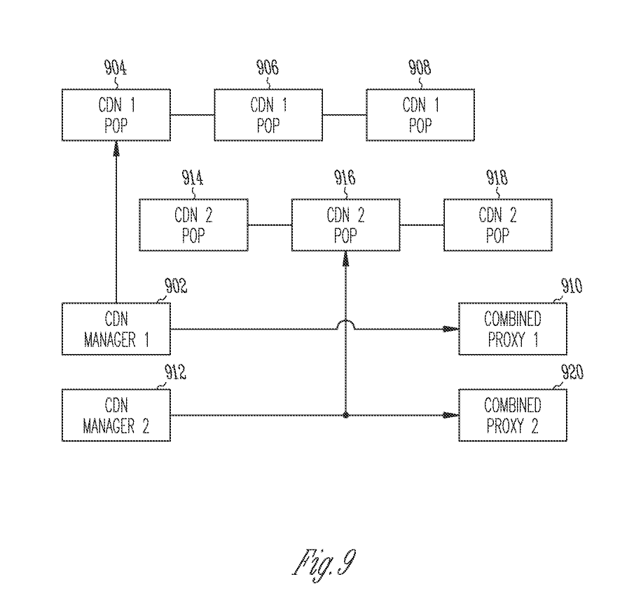

FIG. 9 is an illustrative block diagram representing control relationships among CDN managers and CDN proxies and between CDN managers of combined proxies in accordance with some embodiments. A CDN manager manages configurations of a CDN by updating rules used by the CDN proxy indicating what domains/content providers it supports, how to respond to specific HTTP requests, and specific instructions with regards to managing the cache, to name a few. Unlike an edge forward proxy, CDN proxies log the requests it handles to provide the capability to bill the content providers for the service. Instructions on data logging, aggregations and reporting are also provided by the CDN manager, and typically the logs/billing reports will be sent to a central CDN manager unit that will provide the combined aggregated billing data.

The CDN managers 902, 904 use a normalized API to the respective combined proxies 910, 920, which can be different from the APIs to their own PoP. CDN functionality such as reporting a new domain, purging content, deleting a domain, publish new configuration for a domain are all done through the combined proxy to CDN manager API. Table 1 sets forth common API between the CDN Managers and the combined proxies of FIG. 9. In other words, Table 1 sets forth the functions that are applied by the CDN Managers to both the CDN PoP servers and the combined proxies.

TABLE 1

| Function Name | Description | Comment |
|---|---|---|
| AddDomain | Adding a new CDN domain | |
| | to be recognized by the | |
| | combined proxies | |
| GetLisOf Domains | Get all domains the | |
| | combined proxy consider as | |
| | CDN domain | |
| PurgeContent (or | Cleaning content from | Can be different function |
| flushContent) | cache in combined proxy | call between CDN proxy |
| | and CDN POPs | and Combined proxy |
| PublishCacheConfiguration | Publish a new cache | |
| | configuration of a new | |
| | domain that belong to the | |
| | CDN and need to be update | |
| | in the combined proxies. | |
| PublishCertificate | Published CDN certificate | |
| | into Combined proxy | |
| SetIpForSSLCert | Configure/allocate an IP | In common SSL |
| | address to be used for a | implementations, a |
| | specific SSL certificate | dedicated IP address is |
| | | required per certificate. In |
| | | some implementations of |
| | | SSL (for instance - TLS |
| | | extension) multiple |
| | | certificates can be shared |
| | | with a single IP. |
| GetIpForSSLCert | Get from a shared proxy the | GetIpForSSLCert |
| | allocated IP address for a | |
| | certificate | |
| GetBillingData | Receive in some agreed | GetBillingData |
| | format detailed logs of the | |
| | service provided for a | |
| | content provider by the | |
| | CDN, or specific proxy server | |
| DeleteDomain | Get rid of a domain that is | |
| | not part of the CDN | |
| | anymore and should be | |
| | deleted from the combined | |
| | proxy as well | |

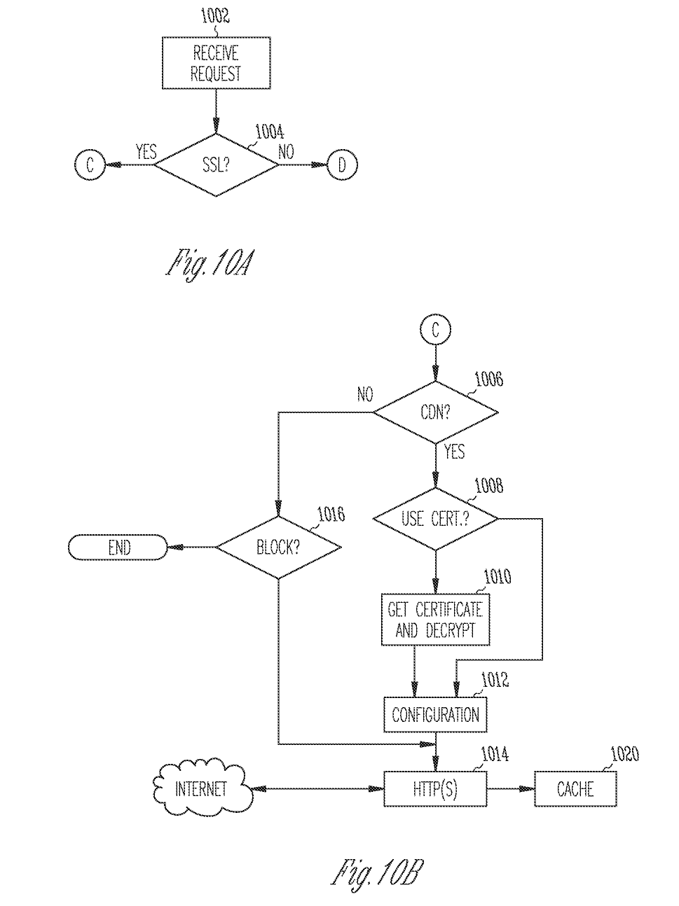

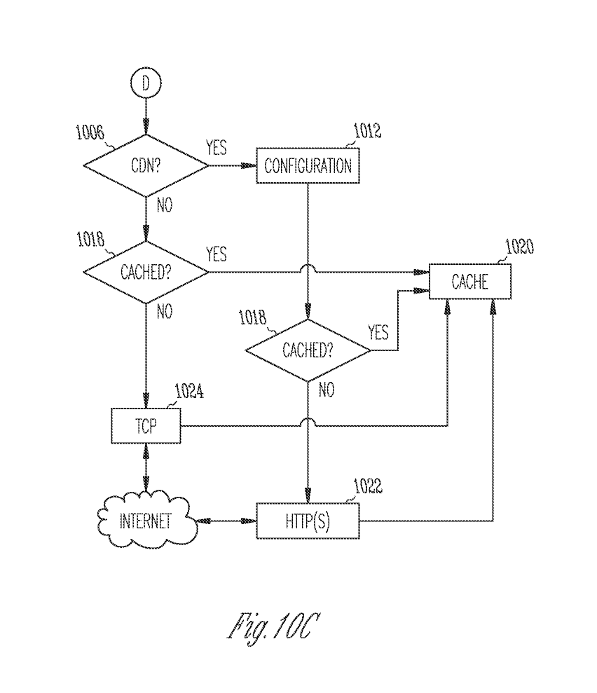

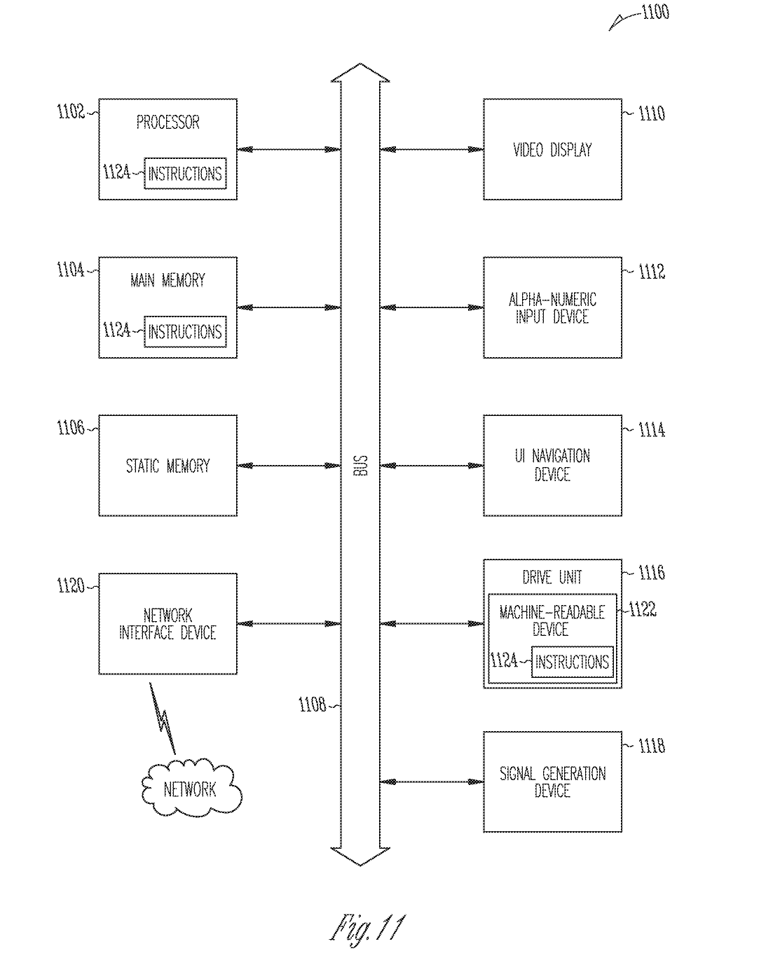

FIGS. 10A-10C are illustrative functional block diagrams showing operation of an alternative embodiment of the combined proxy 400. The alternative embodiment of the combined proxy 400 comprises a computer system that includes one or more processors, storage and network connections and that is configured with computer program code to implement modules described with reference to FIGS. 10A-10C. This alternative combined proxy embodiment makes more clear that some modules are used to perform the same or similar acts at different points in the overall flow. Modules that are used at multiple points in the flow are identified by the same reference numeral at each location in the diagrams of FIGS. 10A-10C. Thus, in some embodiments a single proxy can handle the overall flow utilizing the same modules to perform the same act at different points in the flow.

FIG. 10A is an illustrative flow diagram in which control flow branches based upon whether a received HTTP request is encrypted in an alternative embodiment of the combined proxy server 400. In some embodiments the SSL encryption is used. Module 1002 receives an HTTP request. Decision module 1004 determines whether the received request is encrypted with SSL. If the received request is encrypted with SSL, then control flows to the control flow branch of FIG. 10B. If the received request is not encrypted with SSL, then control flows to the control flow branch of FIG. 10C.

FIG. 10B is an illustrative flow diagram in which an HTTP request determined by decision module 1004 to be encrypted with SSL is processed in accordance with some embodiments. In order to handle the encryption, it is required to determine if the server has the certificate with which to decrypt the content. Decision module 1006 inspects the received connection to determine whether the request is one that is to be handled by a CDN provider to which the proxy has configuration settings. Note that since the received connection is encrypted, no determination can be made yet as to whether it is an HTTP request. Decision module 1006 makes its determination as described above with reference to module 502. The decision may be based upon the IP address, or a combination of an IP address + tcp port − as configured by the CDN service, or by the hostname the request is directed to in the case that the encryption is done over a protocol such as a TLS (Transport Layer Security) extensions as described in RFC 3546 (http://www.ietf.org/rfc/rfc3546.txt) the client can identify in the request, non encrypted, the name of the server they are connecting to.

If decision module 1006 determines that the HTTPS request is directed to a CDN provider, i.e. is a CDN HTTPS request, then decision module 1008 determines whether the CDN provider has the certificate for the required hostname. If decision module 1008 determines that a certificate has been provided, then module 1010 gets the certificate and uses the certificate to establish the HTTPS connection, and can thus decrypt the request and send responses on that link, It will be appreciated that with an SSL implementation the entire connection is encrypted—including the headers. With TLS extensions as specified above—when establishing the connection the client can specify unencrypted the name of the server. The rest of the request will still be encrypted. Configuration module 1012 uses the information decrypted from the HTTPS request to determine rules to apply in processing the received request and may invoke the HTTPS module 1014 in case the requested object/page is not cached locally. In that case—the module will forward the request to the origin server (or to another intermediate proxy) based on the provided configuration/settings. The request can be forwarded to the next hop (origin or intermediate proxy) over an SSL connection, or over a standard HTTP connection, according to the rules indicated in the configuration module 1012. If decision module 1008 determines that a certificate has not been provided, one of two options are available: 1) drop the connection, as the requests can't be decrypted; 2) bypass the proxy and forward the connection to the origin; in the case of “bypassing”—some CDN services offer IP acceleration, or SSL bypass acceleration—by establishing an optimal route and connection to the origin, and delivering the SSL content as is, with out decrypting it, thus without caching or understanding the HTTP requests/responses. In such a case—the origin address (or the next hop address, in case of an intermediate proxy) is determined by the configuration. Note that this is critical, as when delivering content through a CDN the request is typically established to the actual IP address of the proxy server, and not the IP of the final destination server. When the request/connection is entirely encrypted—in order to determine the next server to forward the connection to—the server must have a configuration determining which IP/port determine which service, and what is the IP to forward connections to when receiving a request to this IP/port. When managing a request over a decrypted connection (when the server has the certificate)—like with HTTP handling—cacheable content returned from an origin server (not shown) is stored in cache storage 1020 in accordance with rules specified by the CDN provider.

It will be understood that if we have the certificate—we will use it and we will understand the request: this enables to cache the content, serve request from cache, and apply rules on the specific requests (as you can determine the requested URL, and other header parameters). Specifically—if we can decrypt/encrypt the content—we can hand over the request unencrypted to the HTTP module, that handles HTTP requests and treat it as a standard HTTP request. When we don't have the certificate—we are handling the request as a stream of data. We cannot identify what is a request, when it starts, when ends, what object, and so on. We can only determine where to forward the request to. So when handling that unencrypted request—we are bypassing the entire module that handles HTTP.

If decision module 1006 determines that the HTTP request is not directed to a CDN provider, i.e. is a non-CDN HTTP request, then decision module 1016 determines whether the request is to be blocked. If yes, then the flow ends. If no, then the bypass client module 1014 is invoked to forward the encrypted request to the original IP address the client issued the connection for. in this path—the request and response are not accessible by the proxy as they are encrypted, hence the transparent proxy can't cache or analyze the content. Note that the HTTPS client acts as a client that can encrypt/decrypt HTTPS. In this case—we do not have the certificate/key, and we don't know what the request is, so we simply forward the encrypted stream of bytes. Also, note that the destination IP address is provided on every packet received by an edge forward proxy. By definition—these IP addresses are not the proxy's IP addresses, as the client didn't intend to send the request to the proxy, but directly to the server.

The bypass client may act as a router in this case and simply forward the packets of such a connection (potentially NAT-ing the packets, by changing the source or destination IP and TCP port), or on the TCP level, acting as a TCP proxy—maintaining separate TCP connections to the client and to the origin, and delivering data between them.

It will be appreciated that content/requests for CDN service may get higher priority within the proxy server,with regards to resources such as CPU, memory, and network, IO queus as well as with respect to cache storage 1020, as this is done for a content provider which is paying the CDN to ensure a better service.

FIG. 10C is an illustrative flow diagram in which an HTTP request determined by decision module 1004 to not be encrypted with SSL is processed in accordance with some embodiments. note that in 10B after module 1010 gets the certificate and decrypts the request—it may be delivered to the flow described in this figure, specifically to module 1012, as we already know that the connection is for the CDN part, and at this point the request is already decrypted. Module 1006 determines whether the HTTP request is to be handled by a CDN provider as described above. If decision module 1006 determines that the HTTP request is directed to a CDN provider, then configuration module 1012 gets the customer's configuration/settings and handles the request according to the provided configuration—determining if the request should be treated as cacheable content, dynamic content, or applying other rules. For a request to a cacheable content, the request is forwarded to cache decision module 1018 to determine whether the requested content is cached in local cache storage 1020 of the proxy. It will be appreciated that some content such as DSA (Dynamic Site Acceleration) content is never cached and that other content may be hierarchically cached in a on a different proxy. If the cache decision module 1018 determines that the requested content is cached locally, then the locally cached content is retrieved from cache storage 1020. If the requested content is determined to not be stored in cache storage 1020, then an HTTP client module 1022 is invoked to retrieve the request according to rules set forth in the configuration module 1012. Cacheable content returned from an origin server (not shown) is stored in cache storage 1020 in accordance with rules specified by the CDN provider.

If decision module 1006 determines that the HTTP request is not directed to a CDN provider, then cache decision module 1018 determines whether the requested content is cached in local cache storage 1020 of the proxy as described above. If yes, then the content is retrieved from the cache storage 1020. If no, then a TCP connection 1024 is created as described above with reference to module 513. Cacheable content returned from an origin server (not shown) is stored in cache storage 1020.

As explained above, commonly owned co-pending U.S. patent application Ser. No. 12/758,017, which is incorporated herein, discloses SSL processing involving getting a certificate and use of a configuration file by a CDN proxy.

It will be appreciated that common cache storage 1020 is used to store content returned both for CDN HTTP requests and non-CDN HTTP requests and that a duplicate copy of content returned for a CDN HTTP request is not stored in the cache storage 1020. It will also be appreciated that in the provided figures some of the processes which can actually be implemented as one more complex process were broken to smaller figures for simplicity. A preferred implementation would utilize the components repeated in the different modules and can eliminate some of the steps. For instance—where the CDN customer and its configuration is already determined in the SSL step (for SSL traffic)—after decrypting the request—it can be forwarded to the HTTP part, already indicating the specific customer and configuration, eliminating the need to repeat the decisions on which customer the request is for, and getting the configuration once again.

In some alternative embodiments, services offered by a CDN provider are typically served over defined IP addresses that have been allocated for the CDN. In such alternative embodiments, a selector (e.g., module 502 in FIGS. 5A-5C or module 1006 in FIGS. 10B-10C) uses an IP address to determine whether a request is for a service provided by the CDN or by the edge forward proxy. These IP addresses may be defined within the CDN's DNS server/s to redirect the request for the names service to these IP addresses (see previous applications on CDN service implementation). In contrast, a typical edge forward proxy intercepts requests that are directed to the ‘real’ IP addresses of the original service. As it is common for a proxy to have multiple IP addresses, the proxy can use these IP addresses as a first filtering rule: requests to IP addresses maintained by the CDN will be handled as a CDN request, and requests to all other IP addresses will be treated as requests arriving to an edge forward proxy. This also enables an implementation of a system in which a front-end IP address based load-balancer directs requests for the CDN IPs to the CDN module, and all other requests to an edge forward proxy module. In this implementation, requests arriving at an IP address owned by CDN, but request a service (e.g., hostname) that is not served by the CDN, will be blocked, and not forwarded.

### Architecture and Machine-Readable Storage Device

FIG. 11 is a block diagram of machine in the example form of a computer system 1000 to implement the combined proxy server of FIG. 4 and FIGS. 5A-5C and in FIGS. 10A-10C in accordance with some embodiments. The example computer system 1100 includes a processor 1102 (e.g., a central processing unit (CPU), a graphics processing unit (GPU) or both), a main memory 1104 and a static memory 1106, which communicate with each other via a bus 1108. The computer system 1100 may further include a video display unit 1110 (e.g., a liquid crystal display (LCD) or a cathode ray tube (CRT)). The computer system 1100 also includes an alphanumeric input device 1112 (e.g., a keyboard), a user interface (UI) navigation device 1114 (e.g., a mouse), a disk drive unit 1116, a signal generation device 1118 (e.g., a speaker) and a network interface device 1120.

The disk drive unit 1116 includes a machine-readable storage device 1022 on which is stored one or more sets of instructions and data structures (e.g., software) 1024 embodying or utilized by any one or more of the methodologies or functions described herein. The instructions 1024 may also reside, completely or at least partially, within the main memory 1104 and/or within the processor 1102 during execution thereof by the computer system 1100, the main memory 1104 and the processor 1102 also constituting machine-readable media.

Instructions encoded within one or more of machine-readable devices 1116, 1022, 1024 configure the machine to implement the selector module 502, CDN proxy module 504, edge forward proxy module 506 and HTTP(S) module 510, and TCP connection 513, for example. Specific examples of machine-readable devices include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

The foregoing description and drawings of preferred embodiments in accordance with the present invention are merely illustrative of the principles of the invention. Various modifications can be made to the embodiments by those skilled in the art without departing from the spirit and scope of the invention, which is defined in the appended claims.

1-12. (canceled)

13. A method to respond to an SSL encrypted HTTP request for content accessible over the Internet comprising:
determining whether the request is for content served by a CDN;
if the request is determined to be for content served by a CDN, then using configuration rules to forward the request over the Internet to a server to serve the requested content if the requested content is not stored in the cache storage.
if the request is determined not to be for content served by a CDN, then forwarding the request over the Internet to a server to serve the requested content without using configuration rules.

14. A method to respond to an HTTP request for content accessible over the Internet comprising:
determining whether an HTTP request is encrypted using SSL
determining whether the request is for content served by a CDN;
if the request is determined to be for not SSL encrypted content served by a CDN, then accessing a cache storage to retrieve the content if the requested content is stored in cache storage and accessing configuration rules used by the CDN and using the configuration rules to forward the request over the Internet to a server to serve the requested content if the requested content is not stored in the cache storage;
if the request is determined not to be for not SSL encrypted content not served by a CDN, then accessing the cache storage to retrieve the content if the requested content is stored in the cache storage and forwarding the request over the Internet to a server to serve the requested content without using configuration rules if the content is not stored in the cache storage;
if the request is determined to be for SSL encrypted content served by a CDN, then using configuration rules to forward the request over the Internet to a server to serve the requested content if the requested content is not stored in the cache storage; and
if the request is determined be for SSL encrypted content not served by a CDN, then forwarding the request over the Internet to a server to serve the requested content without using configuration rules.

15.-19. (canceled)

20. An apparatus, comprising:
at least one processor;
a first local cache for storing content requested by client devices that is available from a content delivery network (CDN);
a second local cache for storing content requested by client devices not available from the CDN;
memory holding instructions that, upon execution by the at least one processor, will cause the apparatus to:
receive data from a client device, the data being encrypted in accordance with any of a secure socket layer (SSL) and transport layer security (TLS) protocol;
determine, without decrypting the data, that the data is associated with the CDN;
determine a network address to use for sending the data, based on a configuration provided by the CDN, wherein the network address represents any of a CDN proxy server's network address and an origin server's network address, the origin server being associated with a content provider customer of the CDN;
send the data to the determined network address.

21. The apparatus of claim 20, wherein the apparatus lacks an SSL certificate necessary to decrypt the data.

22. The apparatus of claim 20, wherein the data includes an encrypted HTTP request.

23. The apparatus of claim 20, wherein the apparatus is programmed to determine that the data is associated with the CDN at least in part based on any of (i) an IP address received with the data and (ii) a TCP port over which the proxy received the data.

24. The apparatus of claim 20, wherein the apparatus is programmed (i) to receive from the client device, along with the data, an unencrypted hostname to which the client device is directing the data, and (ii) to determine that the data is associated with the CDN at least in part based on the unencrypted hostname.

25. The apparatus of claim 20, wherein the apparatus is programmed to
receive from the client device an unencrypted hostname to which the client device is directing the data, using Transport Layer Security (TLS) Extensions protocol, and
to determine that the data is associated with the CDN at least in part based on the unencrypted hostname.

26. The apparatus of claim 20, wherein the apparatus is programmed to invoke any of a routing service provided by the CDN and an IP acceleration service provided by the CDN to transport the data.

27. The apparatus of claim 20, wherein the apparatus is located in a point of presence associated with any of an Internet Service provider and a mobile carrier, and the data is received from a wireless client device.

28. The apparatus of claim 20, wherein the apparatus is a gateway associated with any of an Internet service provider and a mobile carrier.

29. The apparatus of claim 20, wherein the apparatus is programmed to receive the configuration from a management module associated with the CDN.

30. The apparatus of claim 20, wherein the configuration comprises a mapping between a destination IP address received with the data and an IP address of the CDN proxy server or an IP address of the origin server.

31. A method operative in a proxy server, comprising:
storing content requested by client devices that is available from a content delivery network (CDN) in a first local cache;
storing content requested by client devices not available from the CDN in a second local cache;
receiving data from a client device, the data being encrypted in accordance with any of a secure socket layer (SSL) and transport layer security (TLS) protocol;
determining, without decrypting the data, that the data is associated with the CDN;
determining a network address to use for sending the data, based on a configuration provided by the CDN, wherein the network address represents any of a CDN proxy server's network address and an origin server's network address, the origin server being associated with a content provider customer of the CDN;
sending the data to the determined network address.

32. The method of claim 31, wherein the data includes an encrypted HTTP request.

33. The method of claim 31, further comprising determining that the data is associated with the CDN at least in part based on any of (i) an IP address received with the data and (ii) a TCP port over which the proxy received the data.

34. The method of claim 31, further comprising (i) receiving from the client device, along with the data, an unencrypted hostname to which the client device is directing the data, and (ii) determining that the data is associated with the CDN at least in part based on the unencrypted hostname.

35. The method of claim 31, further comprising
receiving from the client device an unencrypted hostname to which the client device is directing the data, using Transport Layer Security (TLS) Extensions protocol, and
determining that the data is associated with the CDN at least in part based on the unencrypted hostname.

36. The method of claim 31, further comprising invoking any of a routing service provided by the CDN and an IP acceleration service provided by the CDN to transport the data.

37. The method of claim 31, wherein the proxy server is located in a point of presence associated with any of an Internet Service provider and a mobile carrier, and the data is received from a wireless client device.

38. The method of claim 31, wherein the proxy server is a gateway associated with any of an Internet service provider and a mobile carrier.

39. The method of claim 31, further comprising receiving the configuration from a management module associated with the CDN.

40. The method of claim 31, wherein the configuration comprises a mapping between a destination IP address received with the data and an IP address of the CDN proxy server or an IP address of the origin server.

41. An apparatus, comprising:
at least one processor;
a local cache for storing content requested by client devices that is available from a content delivery network (CDN);
memory holding instructions that, upon execution by the at least one processor, will cause the apparatus to:
receive data from a client device, the data being encrypted in accordance with any of a secure socket layer (SSL) and transport layer security (TLS) protocol;
determine, without decrypting the data, that the data is associated with the CDN;
determine a network address to use for sending the data, based on a configuration provided by the CDN, wherein the network address represents any of a CDN proxy server's network address and an origin server's network address, the origin server being associated with a content provider customer of the CDN;
send the data to the determined network address;
wherein the apparatus is programmed to receive from the client device, along with the data, an unencrypted hostname to which the client device is directing the data, and to determine that the data is associated with the CDN at least in part based on the unencrypted hostname.

42. The apparatus of claim 41, wherein the unencrypted hostname is received using Transport Layer Security (TLS) Extensions protocol.

43. The apparatus of claim 41, wherein the data includes an encrypted HTTP request.

44. The apparatus of claim 41, wherein the apparatus is located in a point of presence associated with any of an Internet Service provider and a mobile carrier, and the data is received from a wireless client device.

45. The apparatus of claim 41, wherein the apparatus is a gateway associated with any of an Internet service provider and a mobile carrier.
